(19) United States
(12) Patent Application Publication
(10) Pub. No.: US 2024/0113298 A1
(43) Pub. Date: Apr. 4, 2024

(54) PROTECTIVE COATINGS FOR LITHIUM METAL ANODES

(71) Applicant: Sakuu Corporation, San Jose, CA (US)

(72) Inventors: Joykumar THOKCHOM, Marietta, GA (US); Ali MODJTAHEDI, Santa Clara, CA (US); Aditya UPRETI, San Jose, CA (US); Arun MENON, San Jose, CA (US)

(73) Assignee: Sakuu Corporation, San Jose, CA (US)

(21) Appl. No.: 17/959,873

(22) Filed: Oct. 4, 2022

(51) Int. Cl. H01M 4/62; H01M 4/04; H01M 4/134; H01M 4/1395; H01M 4/38; H01M 10/052

(52) U.S. Cl. CPC H01M 4/62; H01M 4/0402; H01M 4/134; H01M 4/1395; H01M 4/382; H01M 10/052

(57) ABSTRACT

A lithium cell for a lithium metal battery includes an electrolyte material, a cathode structure arranged on one side of the electrolyte material, the cathode structure including a cathode electrode and a cathode current collector, and an anode structure arranged on an opposite side of the electrolyte material from the cathode structure. The anode structure includes an anode current collector, a lithium metal anode arranged on a side of the anode current collector arranged facing the electrolyte material, a nanoceramic protective coating deposited on a surface of the lithium metal anode arranged facing the electrolyte material. The nanoceramic protective coating includes a nanoceramic material, a base polymer material, a binder material including a UV curable polymer, and one or more lithium salts.

### TECHNICAL FIELD

The present disclosure relates generally to lithium metal batteries, and, in particular, to systems and methods for protecting lithium metal anodes of lithium metal batteries.

### BACKGROUND

Rechargeable lithium metal batteries have superior electrochemical capacity and high operating voltage, thus high energy density. Demand for lithium metal batteries is increasing in the fields of portable information terminals, portable electronic devices, small power storage devices for home use, motorcycles, electric cars, hybrid electric cars, and the like. Hence, improvements to the performance and the safety of lithium metal battery are desired in response to the increasing demand of such applications.

A lithium metal battery typically includes an anode and a cathode separated by an electrically insulating barrier or separator, and the electrolyte medium typically includes one or more lithium salts and one or more organic carbonate solvents with additional additives. During the charging process, the positively charged lithium ions move from the cathode, through the liquid electrolyte soaked/wetted permeable separator, to the anode and reduce into Li metal. During discharge, the Li metal is oxidized to positively charged lithium ions which move from the anode, through the liquid electrolyte soaked/wetted permeable separator, and back to the cathode, while electrons move through an external load from the anode to the cathode, yielding current and providing power for the load.

Conventional lithium-ion batteries using a graphite anode are reaching to the theoretical capacity, leaving little room for the performance improvement. In order to improve the energy density performance, thorough research is thus ongoing these days into lithium metal batteries using a lithium metal as the anode. However, the use of lithium metal in rechargeable batteries poses several major problems. First, when a lithium-metal battery discharges, as electrons move through an external load from the anode simultaneously lithium ions separate from the surface/de-plate of the anode and travel to the cathode. When the battery is charged the lithium ions travel back and deposit/plate onto the anode as lithium metal. But instead of forming a nice smooth plated layer on the anode, lithium metal has the tendency to generate “dendrites” chains of lithium atoms growing from the surface of the anode, which look like the roots of a tree. The dendrites grow bigger with each charge-discharge cycle, eventually reaching the cathode and causing the battery to short, leading to battery failure and potential thermal runway and fires. Second, lithium metal is highly reactive, which means it suffers side reactions with the battery's liquid electrolyte. These undesirable reactions reduce the amount of lithium available and worsen the battery's life with every charge-discharge cycle. Third, lithium batteries may suffer from low Coulombic efficiency (CE), due to the parasitic reactions between lithium and electrolyte to form undesirable solid electrolyte interphase (SEI), leading to the continuous loss of lithium and increased resistance associated with electrolyte consumption and eventual batteries failure.

Time and effort have gone into identifying suitable lithium metal anode protection technologies for alleviating the problems mentioned above. However, for various reasons, an effective protection technology that can lower Li-electrolyte interface resistance to make the interface stable and can increase cycle efficiency of metallic Li and extend cycle life of battery has yet to be developed.

### SUMMARY

In one general aspect, the instant disclosure presents a lithium cell for a lithium metal battery. The lithium cell includes an electrolyte material; a cathode structure arranged on one side of the electrolyte material, the cathode structure including a cathode electrode and a cathode current collector; and an anode structure arranged on an opposite side of the electrolyte material from the cathode structure. The anode structure includes an anode current collector; a lithium metal anode arranged on a side of the anode current collector arranged facing the electrolyte material; and a nanoceramic protective coating deposited on a surface of the lithium metal anode arranged facing the electrolyte material. The nanoceramic protective coating comprises a nanoceramic material, a base polymer material, a binder material including a UV curable polymer, and one or more lithium salts.

In yet another general aspect, the instant disclosure presents a method of providing a protective coating on a lithium metal anode. The method includes combining a nanoceramic material, a base polymer material, a binder material including a UV curable polymer, and one or more lithium salts in a solvent to form a precursor nanoceramic composition; depositing the precursor nanoceramic composition on a surface of the lithium metal anode; and irradiating the precursor nanoceramic composition with an ultraviolet (UV) light for a predetermined length of time to dry and cure the precursor nanoceramic composition to form a nanoceramic protective coating on the surface of the lithium metal anode.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 shows an example of a lithium metal battery cell including a lithium metal anode and a protective coating for the lithium metal anode in accordance with this disclosure.

FIG. 2 shows a cathode structure of the lithium metal cell of FIG. 1.

FIG. 3 shows the anode structure of the lithium metal cell of FIG. 1.

FIG. 4 shows a flowchart of an example method for providing a nanoceramic protective coating on the anode structure of FIG. 3.

FIGS. 5A-5E show examples of anode structures including multiple layers of protective coatings.

FIG. 6 shows the anode structure of FIG. 5 assembled to form a lithium metal battery cell.

FIG. 7 shows a flowchart of an example method for providing a composite polymer electrolyte protective coating on the anode structure of FIG. 3.

### DESCRIPTION

In the following detailed description, numerous specific details are set forth by way of examples to provide a thorough understanding of the disclosed subject matter. It may become apparent to persons of ordinary skill in the art, though, upon reading this disclosure, that one or more disclosed aspects may be practiced without such details. In addition, description of various example implementations according to this disclosure may include referencing of or to one or more known techniques or operations, and such referencing can be at relatively high-level, to avoid obscuring of various concepts, aspects and features thereof with details not particular to and not necessary for fully understanding the present disclosure.

In accordance with this disclosure, protective coatings for coating lithium metal anodes are provided. The protective coatings comprise polymeric, ionically conductive composite materials which may or may not include inorganic particles and various other materials in different formulations for imparting desired characteristics to the coatings and that enable the coatings to be adhered/affixed to a surface of the lithium metal anode, such as by slurry coating and curing using an ultraviolet light (UV) curing process, natural or forced convection or IR solvent drying, sputtering or evaporation (PVD), chemical vapor deposition (CVD), or various combinations of these, depending on the composition of the coating. The protective coatings described below include polymer nanoceramic (referred to herein as “nanoceramic”) protective coatings, polymer and gel-polymer electrolyte protective coatings, pure ceramic protective coatings, and lithium alloy protective coatings. These coatings may be used alone or in combination with each other and/or with other types of protective layer on lithium metal anodes to prevent the lithium anode surface from directly contacting liquid electrolyte and to limit undesired side reactions, such as dendrite formation and unwanted consumption of the liquid electrolyte. The protective coatings may also improve mechanical and thermal stability and improve ionic conductivity while also protecting from lithium consumption and overall safety of the battery.

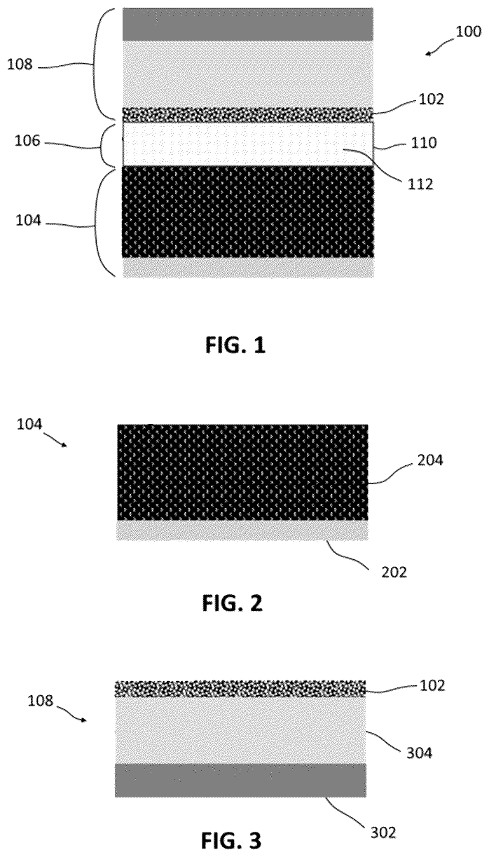

FIG. 1 shows an example of a lithium metal cell 100 for a battery including a protective coating 102 in accordance with this disclosure. As used herein, a “battery” refers to any structure in which chemical energy is converted into electricity and used as a source of power. The terms “battery” and “cell” are generally interchangeable when referring to one electrochemical cell, although the term “battery” can also be used to refer to a plurality or stack of electrically interconnected cells. The lithium cell 100 of FIG. 1 includes a cathode structure 104, an electrolyte region 106, and an anode structure 108.

Referring now to FIG. 2, the cathode structure 104 includes a cathode current collector 202 (also referred to herein as a positive current collector) and a cathode electrode 204. The cathode current collector 202 may be in the form of a plate, sheet, foil, cloth, and the like formed of a suitable conductive material. Examples of materials that may be used to form the cathode current collector 202 include aluminum, stainless steel (with or without a thin carbon coating), titanium, other metal coated with polymer sheet (e.g. polyimide), carbon fiber, carbon sheet/paper, conductive polymer, other polymer-based materials, and the like. The cathode current collector 202 may be formed in any suitable manner and have any suitable thickness. In embodiments, the cathode current collector 202 has a thickness in a range from 5-30 microns. In one particular embodiment, the cathode current collector 202 has a thickness of 12 microns.

The cathode electrode 204 is formed of a suitable cathode active material. For example, the cathode electrode 204 may be formed of a spinel and layered cathode active material. Examples of materials that may be used in the cathode electrode include lithium iron phosphate (LFP), lithium manganese iron phosphate (LMFP), lithium cobalt oxide (LCO), lithium manganese oxide (LMO), lithium nickel cobalt aluminum oxide (NCA), lithium nickel cobalt manganese aluminum oxide (NCMA), lithium nickel manganese cobalt oxide (NMC) and all its variants, lithium nickel manganese oxide (LMNO), Li-rich cathodes, and combinations of these. The cathode current collector may be used as a substrate and mechanical support for the cathode electrode. The cathode electrode 204 is provided on the surface of the collector 202 that is intended to face the electrolyte region 106.

The cathode electrode 204 may be formed on the cathode current collector 202 in any suitable manner. As an example, the cathode active material may be mixed with a conductive additive, or conductivity promoting agent, and a binder material which is coated onto the surface of the cathode current collector 202. Examples of conductive additives that may be used include carbon nanotube (CNT), carbon black, acetylene black, Ketjen black, carbon nanofibers (CNFs), vapor-grown carbon fibers (VGCFs), graphene, conductive metals, alloy powders, and various combinations of these. Examples of binder materials that may be used include polyvinylidene difluoride (PVDF), poly(vinylidene fluoride)-co-hexafluoropropylene (PVDF-HFP), and polytetrafluoroethylene (PTFE). In embodiments, the cathode active material may be infused with an ionic liquid and/or one or more lithium salts. Any suitable ionic liquid and/or lithium salt may be utilized.

In embodiments, the cathode active material, conductive additive, and binder material may be dispersed in a suitable solvent material to form a suspension, or slurry, that is coated onto the surface of the cathode current collector 202. The solvent may then be removed from the suspension, leaving a thin-plate-like electrode. In embodiments, a calendaring process may be utilized to compress the cathode material and the collector together to achieve a desired level of porosity and/or thickness for the cathode material. Any suitable porosity and/or thickness for the cathode electrode may be selected. In embodiments, the cathode electrode may have a porosity in a range 10%-45% and a thickness in a range of 20-120 microns after calendering.

Referring to FIG. 1, the electrolyte region 106 includes a separator 110 and an electrolyte material 112. The separator 110 is a permeable membrane placed between the cathode structure 104 and anode structure 108 primarily to prevent short circuits while also allowing the transport of lithium ions. The separator 110 may be formed of any suitable material. Examples of materials that may be used in the separator 110 include porous single layer polypropylene (PP) or polyethylene (PE), or multilayer polypropylene-polyethylene (e.g., dual layer PP-PE, trilayer PP-PE-PP), nylon or cellophane, PET, PET/PP, cellulose, glass fiber, polyamide, and PVDF and its variants. In embodiments, the separator 110 may include a surfactant and/or ceramic coating on one or both sides of the separator. In embodiments, the separator 110 comprises a trilayer PP-PE-PP with a ceramic coating on one or both sides with or without an additional surfactant coating. The separator 110 may have any suitable porosity and thickness. In embodiments, the separator 110 may be provided with a porosity in a range from 0%-80% and a thickness in a range from 5-100 microns. In embodiments, the protective coating 102 for the anode structure 108 may be used as the separator for the lithium cell such that a porous separator, such as separator 110, may be omitted. In embodiments, the separator and/or the liquid electrolyte may be omitted, such as in solid-state batteries.

In embodiments, the electrolyte material 112 may comprise a liquid electrolyte material that is soaked into the separator 110. Any lithium stable liquid electrolyte or ionic liquid electrolyte may be utilized. The liquid electrolyte may include one or more lithium salts, such as lithium bis(trifluoromethanesulfonyl)imide (LiTFSI), lithium (flurorosulfonyl) (trifluoromethanesulfonypimide (LiFTFSI), lithium bis(fluorosulfonyl) imide (LiFSI), lithium bis(perfluoroethanesulfonyl)imide (LiBETI), lithium hexafluorophosphate (LiPF₆), lithium tetrafluoroborate (LiFB₄), lithium bis(fluorosulfonyl)amide (LiFSA), lithium bis(trifluoromethanesulfonyl)amide (LiTFSA), lithium bis(oxalato)-borate (LiBOB), lithium difluoro(oxalato)borate (LiDFOB), lithium fluoride (LiF), lithium nitrate (LiNO₃), or any lithium salt that dissociates into cation and anion responsible for ionic conduction. The liquid electrolyte may also include one or more organic solvents, such as propylene carbonate (PC), dimethoxyethane (DME), dioxolane (DOL), trimethyl phosphate (TMP), triethyl phosphate (TEP), vinylene carbonate (VC), fluoroethylene carbonate (FEC), bis(2,2,2-trifluoroethyl) ether (BTFE), tetrafluoropropylether (TTE), tris(2,2,2-trifluoroethyl)phosphate (TFEP), dimethyl carbonate (DMC), ethyl-methyl carbonate (EMC), and the like. In embodiments, the liquid electrolyte may include one or more ionic liquids with one or more lithium salts. Any suitable ionic liquid and lithium salt may be utilized. In other embodiments, other types of electrolyte materials may be used including solid and/or hybrid electrolyte materials. In embodiments, the electrolyte material 112 may include multiple types of electrolyte, e.g., solid, hybrid, and liquid, which are provided in layers between the cathode structure 104 and anode structure 108.

Referring now to FIG. 3, the anode structure 108 of the lithium metal cell of FIG. 1 includes an anode current collector 302 (also referred to as a negative current collector), a lithium metal anode 304 (i.e., anode electrode), and a protective coating 102 that has been applied to the lithium metal anode 304. The anode current collector 302 may be in the form of a plate, sheet, foil, cloth, and the like formed of a suitable conductive material. Examples of materials that may be used to form the anode current collector 302 include copper, copper foil, electrodeposited copper foil, copper alloy foil, nickel foil, electrodeposited nickel foil, stainless steel foil, metal coated with polymer sheet (e.g. copper coated with polyimide), carbon sheet/paper, and electronically conducting polymer sheet. The anode current collector 302 may be formed in any suitable manner and have any suitable thickness. In embodiments, the anode current collector 302 is provided with a thickness in a range from 5-30 microns. In one particular embodiment, the anode current collector 302 has a thickness of 8 microns.

The anode electrode 304 is formed of suitable lithium metal material, such as lithium foil. The lithium foil may comprise bare lithium foil, organically cleaned lithium foil, smooth or perforated lithium foil, pure (100%) ceramic nanolayer (LiF, Li₂O, Li₃N, Li₂CO₃, Li₃PO₄, LiPON, BN, MgF₂, SrF₂) directly formed coating or coated lithium foil, nanoceramic composite polymer coated lithium, graphene or CNT with or without Li salt, and binder coated Li foil. In embodiments, the lithium foil is provided with a thickness in a range from 0.1 to 200 microns. In one particular embodiment, the lithium foil is provided with a thickness of 20 microns. The anode current collector 302 may be used as a substrate and mechanical support for the anode electrode 304. The anode electrode 304 is provided on a surface of the anode current collector 302 intended to be arranged facing the electrolyte region 106.

In embodiments, the lithium anode 304 may comprise a lithium alloy material, such as lithium-tin (Li—Sn), lithium-indium (Li—In), Lithium-Galium, lithium-silver (Li—Ag) and combinations of them. In these embodiments, the lithium alloy anode also serves as a protective coating which is more resistant to side reactions, such as dendrite formation and/or unstable SEI formation, than other lithium metal anodes. As described below, lithium alloy coatings may also be used as a protective coating that can be layered with other protective coating to provide additional protection for the lithium anode.

The anode electrode may be formed on the anode current collector 302 in any suitable manner. In embodiments, the lithium foil may be deposited onto the anode current collector 302 (e.g., copper foil) using a suitable thin film deposition technique or method. As examples, lithium foil may be laminated onto copper foil. Evaporation and sputtering techniques may be used as well. Lithium may also be screen printed onto the collector using stabilized lithium powder as a slurry. In embodiments, a calendaring process may be utilized to compress the anode electrode 304 to achieve a desired level of porosity and/or thickness for the anode electrode 304 after the screen printing and drying. In embodiments, the lithium may have a thickness in a range from 0.1 to 200 microns.

In accordance with this disclosure, protective coatings for coating the lithium metal of the anode electrode (also referred to herein as “lithium metal anode”) are provided. In embodiments, the protective coatings, such as nanoceramic coatings and polymer electrolyte coatings, comprise polymeric, ionically conductive composite materials including inorganic particles and various other materials in different formulations for imparting desired characteristics to the coatings and that enable the coatings to be adhered/affixed to a surface of the lithium metal anode, such as by using an ultraviolet light (UV) curing process. In embodiments, non-polymeric protective coatings may be used, such as pure ceramic coatings and lithium alloy coatings. The protective coatings described below, such as nanoceramic protective coatings, polymer electrolyte protective coatings, ceramic protective coatings and lithium alloy coatings, may be provided as single layer or multiple layers and may be used alone or combination with each other and/or other types of protective coatings. The coatings may be non-porous in order to prevent the lithium anode surface from directly contacting liquid electrolyte and to limit undesired side reactions, such as dendrite formation and/or unstable SEI formation leading to unwanted consumption of the liquid electrolyte and Li metal itself. The protective coatings may also improve mechanical and thermal stability and improve ionic conductivity while also protecting from lithium consumption and overall safety of the battery.

A nanoceramic protective coating for the lithium metal anode includes inorganic particles in the form of nanoceramics. In embodiments, the nanoceramics have a particle size in a range from 10-1000 nm, and in one particular embodiments, has a particle size of approximately 100 nm. Nanoceramics may be ionically conductive or non-conductive. Examples of ionically conductive nanoceramics that may be used include lithium lanthanum zirconium oxide (LLZO) and its single or multiple cation doped variants (e.g., tantalum doped LLZO and Ga, Nb or Mg, Sr doped LLZO), any garnet system, and lithium nitride (Li₃N). Examples of non-conducting nanoceramics that may be used include lithium fluoride (LiF), lithium phosphate (Li₃PO₄), lithium carbonate (Li₂CO₃), lithium oxide (Li₂O), boron nitride (BN), fluorides (MgF₂, SrF₂), titanium dioxide (TiO₂), aluminum oxide (Al₂O₃), silicon dioxide (SiO₂), or any lithium stable nanoceramic material.

The nanoceramic is dispersed in a polymer base material. Examples of polymer base materials that may be used include polyvinylidene difluoride (PVDF), polyethylene oxide (PEO) or polyoxyethylene (POE) or polyethylene glycol (PEG), polyethylene glycol dimethyl ether (PEGDME), polyacrylonitrile (PAN), poly(methyl methacrylate) (PMMA), poly(oligo(oxyethylene)methacrylate) (POEM), polydimethylsiloxane (PDMS), polyethylene glycol monoacrylate (PEGMA), polyethylene glycol diacrylate (PEGDA), polyethylene glycol dimethacrylate (PEGDMA) poly(vinylidene fluoride-hexafluoropropylene) (PVDF-HFP), liquid crystals, such as liquid crystalline diacrylates (C3M, C6M, etc.), or any polymer that is stable with lithium and dissolvable in a selected process solvent. The nanoceramic is dispersed in the polymer using a suitable dispersant, such as Acumer, Solsperse, Tego dispers, Disperbyk, lithium stearate or any other dispersant stable with lithium and soluble with the selected solvent, or any dispersant capable of dispersing ceramics in a polymeric matrix.

The nanoceramic coating includes a binder material that is formed of an ultraviolet light (UV) curable polymer that enables the coating to be cured by exposing the coating to UV light for a predetermined amount of time, e.g., 3 seconds to 5 minutes. The UV curable polymer may comprise any lithium stable UV-curable polymer. In embodiments, the UV curable polymer may comprise a UV curable adhesive material, such as a UV curable super glue, which addresses the issue of poor bonding of the nanoceramic coating on lithium surface. One or more lithium salts may be added to the UV curable polymer to improve the ionic conductivity of the polymer. Examples of lithium salts that may be added to the UV curable polymer include lithium bis(trifluoromethanesulfonyl)imide (LiTFSI), lithium (flurorosulfonyl) (trifluoromethanesulfonyl)imide (LiFTFSI), lithium bis(fluorosulfonyl) imide (LiFSI), lithium bis(fluorosulfonyl)amide (LiFSA), lithium bis(trifluoromethanesulfonyl)amide (LiTFSA), lithium bis(perfluoroethanesulfonyl)imide (LiBETI), lithium hexafluorophosphate (LiPF₆), lithium tetrafluoroborate (LiFB₄), lithium bis(oxalato)-borate (LiBOB), lithium difluoro(oxalato)borate (LiDFOB), lithium perchlorate (LiClO₄) or any lithium salt that dissociates into cation and anion responsible for ionic conduction. In embodiments, the UV curable polymer may include other conductive additives, such as carbon, for improving conductivity of the coating.

In embodiments, the materials used to form the nanoceramic coating, i.e., the nanoceramic, polymer, UV curable polymer binder with lithium salts, dispersant, etc., are combined in predetermined ratios/amounts to the coating. For example, the polymer may be provided for the coating in a range from 1-90 wt. %, the nanoceramic may be provided in a range from 0-80 wt. %., the UV curable polymer may be provided in a range from 0.01-10 wt. %, the lithium salts may be provided in a range from 1-50 wt. %, and the dispersant may be provided in a range from 0.001-5 wt. %. The ratios/amounts of materials used in the coating may be varied to control various properties of the coating, such as ion conduction, electronic conduction, mechanical stability, porosity and the like. In embodiments, the nanoceramic coating is applied and cured such that the coating has a thickness in a range of 3-15 microns. In one particular embodiment, the nanoceramic coating has a thickness of 5 microns.

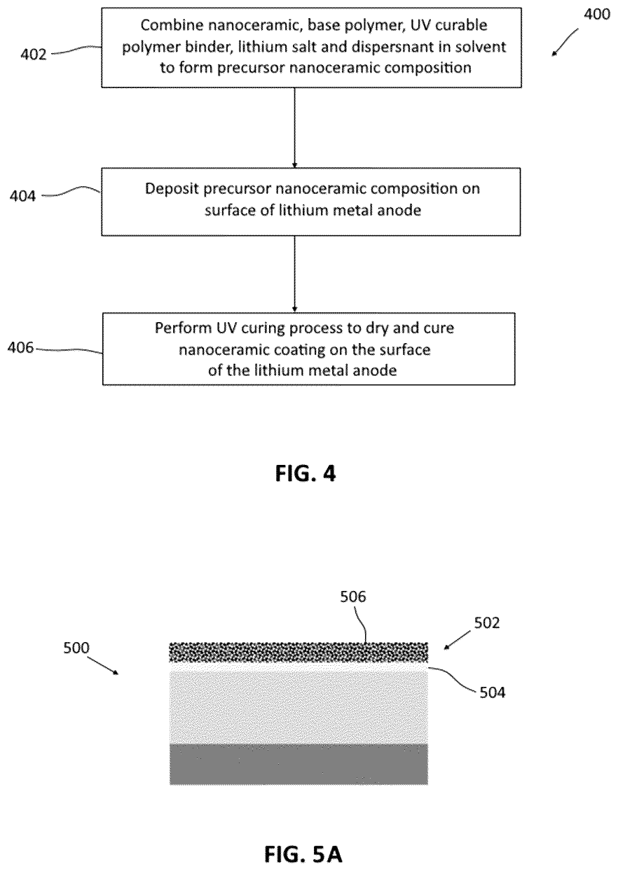

The nanoceramic coating may be applied to the lithium metal anode (e.g., lithium foil) in any suitable manner. An example of a method 400 for providing a nanoceramic protective coating on a lithium metal anode is depicted in FIG. 4. The method 400 begins with dispersing the nanoceramic coating materials, such as the nanoceramic, base polymer, UV curable polymer binder, lithium salts, and dispersant, are combined in a suitable solvent material to form a precursor composition (block 402). In embodiments, the precursor composition may comprise a slurry although it is also possible for the composition to be in the form of a solution or suspension. The precursor composition is then coated onto the surface of the lithium metal anode (block 404). In embodiments, the precursor composition is spread onto the lithium metal surface using a blade although any suitable method of applying or depositing the coating onto the surface of the lithium metal anode may be used. The coating may then be dried and cured, e.g., using a UV lamp to irradiate the coating with a for a predetermined amount of time (e.g., 3 seconds to 5 minutes) (block 406).

Once the anode structure 108 (with nanoceramic protective coating) and cathode structure 104 have been formed, the lithium cell 100 as shown in FIG. 1 may be assembled from these parts in any suitable manner. In embodiments, the cathode structure 104, electrolyte region 106, and anode structure 108 may be stacked to form the cell. Electrolyte may then be added to the separator. One or more cells may be connected in series and/or parallel and packaged in any suitable manner to form a battery, battery pack, or battery module.

A lithium metal anode with a nanoceramic coating in accordance with this disclosure provides numerous advantages and improvements over previously known lithium anodes and lithium anode protection measures. For example, the nanoceramic coating may be non-porous to prevent the lithium metal anode from contact with electrolyte material, particularly liquid electrolyte material. The nanoceramic coating has an easily controllable thickness. The coating provides good interfacial resistance, is scalable and inexpensive. The nanoceramic coating is capable of suppressing lithium dendrite formation, improving mechanical and thermal stability, protecting from lithium consumption, and, perhaps most importantly, preventing the lithium metal anode from directly contacting the liquid electrolyte which works to minimize or eliminate consumption of liquid electrolyte, and improving overall safety of the battery.

As noted above, the protective coating 102 for the lithium metal anode 304 may comprise polymer electrolyte coatings. The polymer electrolyte may comprise a composite polymer electrolyte (CPE), solid polymer electrolyte (SPE), gel-polymer electrolyte (GPE), gel composite polymer electrolyte (GCPE), and the like. The polymer electrolyte coating has a material composition that includes a base polymer material (which in this case is used as a binder for the composition), lithium salts for ionic conductivity, and an inorganic filler material. Examples of polymers that may be used for the UV curable polymer electrolyte coating include PEGDA, PEGMA, PEGDMA, PVDF-HFP, PVDF, PEO, PEG, PAN, PMMA, BEMA, combination of above and all possible Li stable polymer materials. Examples of lithium salts that may be used include any lithium stable salt, such as lithium bis(trifluoromethanesulfonyl)imide (LiTFSI), lithium (flurorosulfonyl) (trifluoromethanesulfonypimide (LiFTFSI), lithium bis(fluorosulfonyl) imide (LiFSI), lithium bis(fluorosulfonyl)amide (LiFSA), lithium bis(trifluoromethanesulfonyl)amide (LiTFSA), lithium bis(perfluoroethanesulfonyl)imide (LiBETI), lithium hexafluorophosphate (LiPF₆), lithium tetrafluoroborate (LiFB₄), lithium bis(oxalato)-borate (LiBOB), lithium perchlorate (LiClO₄), lithium difluoro(oxalato)borate (LiDFOB), any lithium stable, or any combination of these. In embodiments, auxiliary electrolyte may be included to enhance the conductive properties of the coating, such as nonflammable Li stable, non-solvent-based electrolyte. The polymer electrolyte coating may have any suitable concentration of lithium salt. For example, in embodiments, the polymer electrolyte coating may comprise a high concentrated electrolyte (HCE).

The inorganic filler materials are mostly chemically inert but have a high dielectric constant to enhance ion conductivity and high voltage stability. Inorganic filler may include ceramics, nanoceramics, or materials having similar properties. The blending of polymer electrolytes with an inorganic filler may enhance ion mobility and conductivity of the polymer electrolyte while improving the mechanical strength of the polymer. Examples of inorganic fillers that may be used include lithium garnets, such as LLZO, LLZO doped with Al, Ta, Nb and Ga, etc., multivalent doped LLZO garnet, and the like, NASICON powder such as lithium aluminium germanium phosphate (LAGP) and lithium aluminum titanium phosphate (LATP), inactive fillers (such as Al₂O₃, TiO₂, ZnO, SiO₂, and the like), or any possible conventional fillers.

The polymer electrolyte protective coating also may include a dispersant, a plasticizer, a polymerization initiator (e.g., thermal and/or photo), and a rheology modifier. The dispersant is used to disperse particles, such as the inorganic filler, in the base polymer material. Any suitable dispersant may be used. Plasticizers may be added to polymer electrolytes to enhance the ionic conductivity and the film-forming capability of coating. In particular, the addition of plasticizer lowers the glass transition temperature of the polymer and effectively enhances salt dissociation into the polymer matrix which increases the ability of the polymer electrolyte to transport ions. Any suitable plasticizer or fire-retardant plasticizer may be used, such as triethylene glycol dimethyl ether (triglyme, TEGDME), succinonitrile (SCN), triphenyl phosphate (TPP), or any Li compatible plasticizer.

The polymerization initiator is a compound that generates radicals or cations upon exposure to heat and/or light. The polymerization initiator is used to initiate polymerization (i.e., curing) of the composition in response to being irradiated by UV light or being subjected to heat. Any suitable thermal and/or photo initiator may be used. A rheology modifier is included in the composition. Rheology modifiers are additives to polymer compositions that may be used to alter the rheologic properties (e.g., deformation and flow characteristics) of a composition. In embodiments, the rheology modifier comprises an acrylic polymer diluted by a reactive diluent which is used as the primary or a modifying oligomer in UV or electron beam (EB) curable formulations to improve film properties such as adhesion and lay-down. In this case, the rheology modifier may be used to promote adhesion and lay-down of the coating on the surface of the lithium metal anode.

In embodiments, the materials used to form the polymer electrolyte coating, i.e., such as the base polymer, lithium salts, inorganic filler, dispersant, plasticizer, polymerization initiator, auxiliary electrolyte (non-flammable ionic conduction enhancer), and rheology modifier, are combined in predetermined ratios/amounts to the coating. For example, the base polymer may be provided for the coating in a range from 20-40 wt. %, the lithium salts may be provided in a range from 10-25 wt. %, auxiliary electrolyte may be provided in a range from 10-70 wt. %, the initiator may be provided in a range from 0.05-2 wt. %, the plasticizer may be provided in range from 2-30 wt. %, the inorganic filler may be provided in a range from 10-95 wt. %, the dispersant may be provided in a range from 0.5-2 wt. %, and the rheology modifier may be provided in a range from 1-15 wt. %. The ratios/amounts of materials used in the coating may be varied to control various properties of the coating, such as ion conduction, electronic conduction, mechanical stability, porosity and the like. In embodiments, the polymer electrolyte coating is applied and cured such that the coating has a thickness in a range of 1-40 microns. The polymer electrolyte coating may be dried and cured in any suitable manner, such as by drying using natural or forced convection heating or IR radiation, and by curing using an ultraviolet light (UV) curing process, or various combinations of these.

Similar to the nanoceramic coating, the polymer electrolyte coating may be applied to the lithium metal anode (e.g., lithium foil) in any suitable manner. An example of a method 700 for providing a polymer electrolyte protective coating on a lithium metal anode is shown in FIG. 7. The method begins with combining the polymer electrolyte coating materials, such as the base polymer, lithium salts, inorganic filler, dispersant, plasticizer, polymerization initiator, and rheology modifier, auxiliary non-flammable electrolyte in a suitable solvent material to form a precursor composition (block 702). In embodiments, the precursor composition may comprise a slurry although it is also possible for the composition to be in the form of a solution or suspension. The precursor composition is then coated onto the surface of the lithium metal anode (block 704). In embodiments, the precursor composition is spread onto the lithium metal surface using a blade although any suitable method of applying or depositing the coating onto the surface of the lithium metal anode may be used. The polymer electrolyte coating may then be dried and cured in any suitable manner, such as by drying using natural or forced convection heating or IR radiation, and by curing using an ultraviolet light (UV) curing process, or various combinations of these (block 706).

Similar to the nanoceramic protective coating, the polymer electrolyte protective coating on a lithium metal anode provides numerous advantages and improvements over previously known lithium anodes and lithium anode protection measures. For example, the coating should be non-porous to prevent the lithium metal anode from contact with electrolytes, has controllable thickness, provides good interfacial resistance, and is scalable and inexpensive. The polymer electrolyte coating is capable of suppressing lithium dendrite formation, improving battery safety (e.g. passing nail penetration test), improving ionic conductivity, improving mechanical and thermal stability, protecting from lithium consumption, and, perhaps most importantly, preventing the lithium metal anode from directly contacting the liquid electrolyte which works to minimize or eliminate consumption of liquid electrolyte.

In embodiments, other protective coatings may be provided as an alternative or in addition to the above-described coatings. As one example, protective coatings in the form of ceramic coatings may be provided. In embodiments, ceramic materials such as lithium phosphorus oxynitride (LiPON), aluminum oxide (Al₂O₃), titanium dioxide (TiO₂), zinc oxide (ZnO), and the like, which may be coated onto the lithium metal anode or onto other coatings using a suitable technique, such as atomic layer deposition (ALD), sputtering, and evaporation. In some embodiments, a protective coating may comprise a lithium alloy material, such as lithium-tin (Li—Sn), lithium-indium (Li—In), lithium-silver (Li—Ag), lithium-gallium (Li—Ga), and any binary or tertiary combination of those, etc. In embodiments, the lithium alloy coating may be used to replace the lithium anode or layered on top of a lithium metal anode or a lithium alloy anode to provide additional protection for the anode.

As discussed above, protective coatings may be provided as a single layer, such as depicted in FIG. 3, of one of the types of protective coatings described above. In embodiments, protective coatings may be provided with multiple layers having the same or different types of coatings. For example, the protective coating may comprise multiple layers of combinations of ceramic and nanoceramic protective coatings, combinations of ceramic and polymer electrolyte protective coatings, combinations of lithium alloy and nanoceramic protective coatings, and lithium alloy and polymer electrolyte protective coatings.

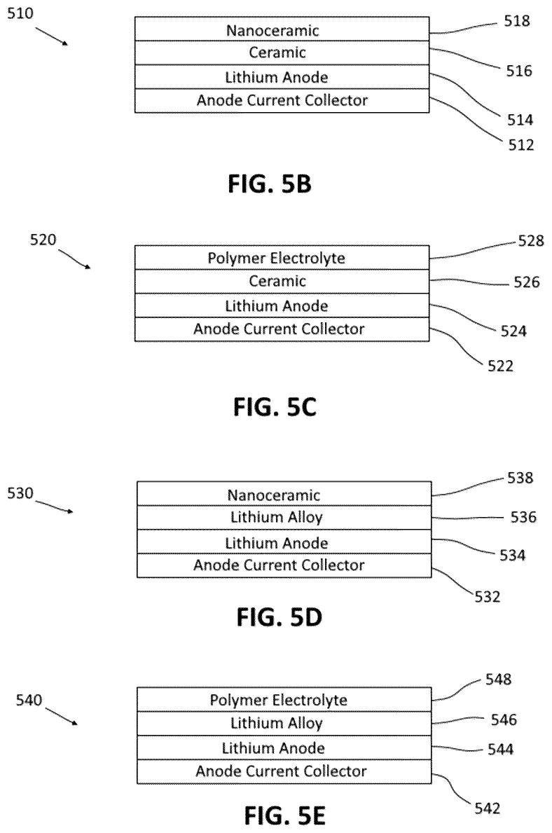

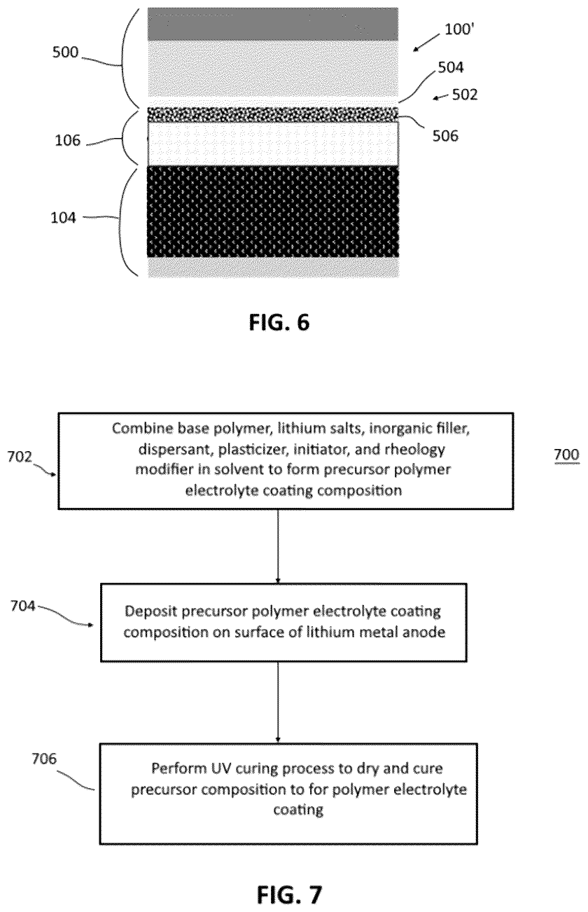

An example of a lithium cell 100 having an anode structure 500 with a multi-layer nanoceramic coating 502 is shown in FIG. 5A. In this example, the multi-layer nanoceramic coating 502 includes a first ceramic layer 504 and a second layer 506 which corresponds to the nanoceramic layer. The first ceramic layer 504 is deposited directly onto the surface of the lithium metal anode 508. The nanoceramic coating 506 is then applied on top of the first ceramic layer. The first ceramic layer 504 may be formed of a thin layer of pure (e.g., 100%) ceramic, such as lithium phosphorus oxynitride (LiPON), aluminum oxide (Al₂O₃), titanium dioxide (TiO₂), zinc oxide (ZnO), lithium phosphate (Li₃PO₄), etc., with or without microcracks using a high-volume scalable solution method or dense almost pore free LiₓPO_{y}N_{z} (x≈3, z<0.5, and 3<(y+z)<4), LiF, MgF₂, SrF₂ sputtered on lithium using low volume scalable dry method or, in some cases, by metal organic chemical vapor deposition (MOCVD), e.g., MgF₂, before coating with the nanoceramic composite. The nanoceramic layer 506 may then be applied onto the first ceramic layer 504 as described above. The additional coating layer 504 provides double protection of lithium metal further ensuring non-contact with liquid electrolyte, non-consumption of lithium, dendrite suppression, improved safety during thermal runaway by shielding lithium from exposure to fresh oxygen gas release from the cathode active material. FIG. 6 shows the cell assembly 100 for the anode structure 500 having the two-layer protective coating 502 of FIG. 5 including the electrolyte region 106 and cathode structure 104, as described above.

FIGS. 5B-5E show additional non-limiting examples of protective coatings with multiple layers of different types of coatings. FIG. 5B shows an embodiment of an anode structure 510 including an anode current collector 512 and lithium anode 514 and a protective coating having a pure ceramic coating 516 and a nanoceramic coating 518. FIG. 5C shows an embodiment of an anode structure 520 that includes an anode current collector 522 and a lithium anode 524 and a protective coating having a pure ceramic coating 526 and a polymer electrolyte coating 528.

The embodiments of FIGS. 5D and 5E show combinations of protective coatings including lithium alloy. For example, FIG. 5D shows an embodiment of an anode structure 530 including an anode current collector 532 and lithium anode 534 and a protective coating comprising a lithium alloy layers 536 and a nanoceramic layer 538 formed on the lithium alloy layer 534. Alternatively, the lithium alloy layer 536 can be formed directly on the anode current collector and serve as the anode for the anode structure. FIG. 5E shows an embodiment of an anode structure 540 including an anode collector 542 and lithium anode 544 and a protective coating comprising a lithium alloy layer 546 and a polymer electrolyte layer 548 formed on the lithium alloy layer 546. Alternatively, the lithium alloy layer 546 can be formed directly on the anode current collector and serve as the anode for the anode structure.

In the following, further features, characteristics, and advantages of the instant application will be described via the following items:
Item 1. A lithium cell for a lithium metal battery comprising:
   an electrolyte material;
   a cathode structure arranged on one side of the electrolyte material, the cathode structure including a cathode electrode and a cathode current collector; and
   an anode structure arranged on an opposite side of the electrolyte material from the cathode structure, the anode structure including:
      an anode current collector;
      a lithium metal anode arranged on a side of the anode current collector arranged facing the electrolyte material; and
      a nanoceramic protective coating deposited on a surface of the lithium metal anode arranged facing the electrolyte material, the nanoceramic protective coating including:
         a nanoceramic material;
         a base polymer material;
         a binder material including a UV curable polymer; and
         one or more lithium salts.
Item 2. The lithium cell of item 1, wherein the nanoceramic material is formed of an ionically conductive nanoceramic material.
Item 3. The lithium cell of any of items 1 and 2, wherein the nanoceramic material is formed of an ionically non-conductive nanoceramic material.
Item 4. The lithium cell of any of items 1-3, wherein the electrolyte material is a liquid electrolyte or ionic liquid electrolyte material.
Item 5. The lithium cell of any of items 1-4, wherein the lithium metal anode is lithium foil or lithium deposited on the current collector using a suitable thin film deposition technique or method or screen printing using stabilized lithium powder or thermal evaporation and has a thickness in a range from 0.1-200 microns.
Item 6. The lithium cell of any of items 1-5, wherein the UV curable polymer comprises one of a UV curable adhesive, a UV curable liquid plastic, a photocurable resin, and a thermal curable resin.
Item 7. The cell of any of items 1-6, wherein the nanoceramic protective coating has a thickness in a range 3-15 microns.
Item 8. The cell of any of items 1-7, wherein the lithium salt comprises at least one of LiTFSI, LiFTFSI, LiFSI, LiFSA, LiTFSA, LiBETI, LiPF₆, LiFB₄, LiBOB, and LiDFOB.
Item 9. The lithium cell of any of items 1-8, further comprising a first ceramic coating coated directly onto the surface of the lithium metal anode, and wherein the nanoceramic protective coating is coated onto the first ceramic coating.
Item 10. The lithium cell of any of items 1-9, wherein the nanoceramic protective coating is non-porous.
Item 11. A method of providing a protective coating on a lithium metal anode, the method comprising:
   combining a nanoceramic material, a base polymer material, a binder material including a UV curable polymer, and one or more lithium salts in a solvent to form a precursor nanoceramic composition;
   depositing the precursor nanoceramic composition on a surface of the lithium metal anode; and
   irradiating the precursor nanoceramic composition with an ultraviolet (UV) light for a predetermined length of time to dry and cure the precursor nanoceramic composition to form a nanoceramic protective coating on the surface of the lithium metal anode.
Item 12. The method of item 11, wherein the nanoceramic material is formed of an ionically conductive nanoceramic material.
Item 13. The method of any of items 11 and 12, wherein the nanoceramic material is formed of an ionically non-conductive nanoceramic material.
Item 14. The method of any of items 11-13, wherein depositing the precursor nanoceramic composition comprises spreading the precursor nanoceramic composition on the surface of the lithium metal anode using a blade.
Item 15. The method of any of items 11-14, wherein the precursor nanoceramic composition comprises a slurry.
Item 16. The method of any of items 11-15, wherein the UV curable polymer comprises one of a UV curable adhesive, a UV curable liquid plastic, a photocurable resin, and a thermal curable resin.
Item 17. The method of any of items 11-16, wherein the lithium salt comprises at least one of LiTFSI, LiFTFSI, LiFSI, LiFSA, LiTFSA, LiBETI, LiPF₆, LiFB₄, LiBOB, and LiDFOB.
Item 18. The method of any of items 11-17, further comprising a first ceramic coating coated directly onto the surface of the lithium metal anode, and wherein the nanoceramic protective coating is coated onto the first ceramic coating.
Item 19. The method of any of items 11-18, the first ceramic coating or directly formed onto the surface of the lithium metal anode is selected from LiF, Li₂O, Li₂CO₃, Li₃PO₄, LiPON, BN, MgF₂, SrF₂.
Item 20. The method of any of items 11-19, wherein the nanoceramic protective coating has a thickness in a range 3-15 microns.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. For example, although described as a method for curing and bonding non-cured layers to a stack of cured layers, the methodology can be applied to any layer of material which is created in one phase (e.g., fluid), to which energy is subsequently applied to convert the layer or material to another phase (e.g., solid), while simultaneously being bonded to previously bonded layers. For example, thermoplastic layers to which heat can be applied to convert them into bonding layers; or monomers, which can be polymerized to form polymers using heat.

Unless otherwise stated, all measurements, values, ratings, positions, magnitudes, sizes, and other specifications that are set forth in this specification are approximate, not exact. They are intended to have a reasonable range that is consistent with the functions to which they relate and with what is customary in the art to which they pertain.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

What is claimed is:

1. A lithium cell for a lithium metal battery comprising:
an electrolyte material;
a cathode structure arranged on one side of the electrolyte material, the cathode structure including a cathode electrode and a cathode current collector; and
an anode structure arranged on an opposite side of the electrolyte material from the cathode structure, the anode structure including:
an anode current collector;
a lithium metal anode arranged on a side of the anode current collector arranged facing the electrolyte material; and
a nanoceramic protective coating deposited on a surface of the lithium metal anode arranged facing the electrolyte material, the nanoceramic protective coating including:
a nanoceramic material;
a base polymer material;
a binder material including a UV curable polymer; and
one or more lithium salts.

2. The lithium cell of claim 1, wherein the nanoceramic material is formed of an ionically conductive nanoceramic material.

3. The lithium cell of claim 1, wherein the nanoceramic material is formed of an ionically non-conductive nanoceramic material.

4. The lithium cell of claim 1, wherein the electrolyte material is a liquid electrolyte or ionic liquid electrolyte material.

5. The lithium cell of claim 1, wherein the lithium metal anode is lithium foil or lithium deposited on the current collector using a suitable thin film deposition technique or method or screen printing using stabilized lithium powder or thermal evaporation and has a thickness in a range from 0.1-200 microns.

6. The lithium cell of claim 1, wherein the UV curable polymer comprises one of a UV curable adhesive, a UV curable liquid plastic, a photocurable resin, and a thermal curable resin.

7. The cell of claim 1, wherein the nanoceramic protective coating has a thickness in a range 3-15 microns.

8. The cell of claim 1, wherein the lithium salt comprises at least one of LiTFSI, LiFTFSI, LiFSI, LiFSA, LiTFSA, LiBETI, LiPF₆, LiFB₄, LiBOB, and LiDFOB.

9. The lithium cell of claim 1, further comprising a first ceramic coating coated directly onto the surface of the lithium metal anode, and
wherein the nanoceramic protective coating is coated onto the first ceramic coating.

10. The lithium cell of claim 9, wherein the nanoceramic protective coating is non-porous.

11. A method of providing a protective coating on a lithium metal anode, the method comprising:
combining a nanoceramic material, a base polymer material, a binder material including a UV curable polymer, and one or more lithium salts in a solvent to form a precursor nanoceramic composition;
depositing the precursor nanoceramic composition on a surface of the lithium metal anode; and
irradiating the precursor nanoceramic composition with an ultraviolet (UV) light for a predetermined length of time to dry and cure the precursor nanoceramic composition to form a nanoceramic protective coating on the surface of the lithium metal anode.

12. The method of claim 11, wherein the nanoceramic material is formed of an ionically conductive nanoceramic material.

13. The method of claim 11, wherein the nanoceramic material is formed of an ionically non-conductive nanoceramic material.

14. The method of claim 11, wherein depositing the precursor nanoceramic composition comprises spreading the precursor nanoceramic composition on the surface of the lithium metal anode using a blade.

15. The method of claim 11, wherein the precursor nanoceramic composition comprises a slurry.

16. The method of claim 11, wherein the UV curable polymer comprises one of a UV curable adhesive, a UV curable liquid plastic, a photocurable resin, and a thermal curable resin.

17. The method of claim 11, wherein the lithium salt comprises at least one of LiTFSI, LiFTFSI, LiFSI, LiFSA, LiTFSA, LiBETI, LiPF₆, LiFB₄, LiBOB, and LiDFOB.

18. The method of claim 11, further comprising a first ceramic coating coated directly onto the surface of the lithium metal anode, and
wherein the nanoceramic protective coating is coated onto the first ceramic coating.

19. The method of claim 11, the first ceramic coating or directly formed onto the surface of the lithium metal anode is selected from LiF, Li₂O, Li₂CO₃, Li₃PO₄, LiPON, BN, MgF₂, SrF₂.

20. The method of claim 11, wherein the nanoceramic protective coating has a thickness in a range 3-15 microns.
